(19) United States
(12) Patent Application Publication
(10) Pub. No.: US 2026/0171683 A1
(43) Pub. Date: Jun. 18, 2026

(54) SEPARATING SYSTEM COMPRISING A BODY AND A MOVABLE WEDGE FOR ELECTRICAL CONDUCTORS

(71) Applicant: SOCIETE INDUSTRIELLE DE CONSTRUCTION D'APPAREILS ET DE MATERIEL ELECTRIQUES, Arnac-Pompadour (FR)

(72) Inventor: Frédéric AMOUROUX, Arnac-Pompadour (FR)

(73) Assignee: SOCIETE INDUSTRIELLE DE CONSTRUCTION D'APPAREILS ET DE MATERIEL ELECTRIQUES, Arnac-Pompadour (FR)

(21) Appl. No.: 19/126,992

(22) PCT Filed: Nov. 3, 2022
(86) PCT No.: PCT/FR2022/052070

§ 371 Date: May 2, 2025

(51) Int. Cl. H01R 4/08; H01R 43/027

(52) U.S. Cl. CPC H01R 4/08; H01R 43/0275

(57) ABSTRACT

A separating system that includes a body, an upper shoe and a lower shoe, wherein the shoes are sliding inside the body between close-together and separated positions, means for locking in the separated position, and an explosive system that has a barrel with an end sliding in an upper bore and a proximal end mounted in a lower bore, an explosive cartridge of the annular percussion type housed in the barrel, a firing pin having a percussion zone and sliding between a waiting position where the percussion zone is at a distance from the bead and a percussed position where the percussion zone strikes the rim, a spring element that constrains the firing pin in the percussed position, and a removable holding system that holds the firing pin in the waiting position.

### TECHNICAL FIELD

The present invention relates to a separating system comprising a hollow body and a movable wedge housed in the hollow body and intended to be used with electrical conductors, wherein each electrical conductor is wedged between the body and the wedge.

### PRIOR ART

The document WO-A-2016/037289 shows a separating system of the prior art that comprises a body and a movable wedge. Such a separating system is used for guaranteeing the separation and holding of two electrical conductors with respect to each other. The two conductors are arranged parallel to each other and are disposed on either side of the movable wedge between said movable wedge and the body.

The movable wedge comprises two shoes that are mounted so as to be able to slide with respect to each other inside the body and along a surface that is inclined with respect to the longitudinal direction of each conductor.

Each electrical conductor is disposed between an interior surface of the body and an exterior surface of one of the shoes.

The separating system also comprises an explosive system which, when it is activated, propels the two shoes in opposite directions to each other in order to separate the two exterior surfaces to bring them closer to the associated interior surfaces and to grip each electrical conductor between an exterior surface and an interior surface.

The separating system also comprises locking means that keep the two shoes separated. The locking means are implemented here by notches produced in each shoe and which interact with each other to block the translation of the two shoes.

The explosive system comprises a barrel in which an explosive cartridge with central percussion is introduced and the barrel is inserted in bores produced in the shoes. The explosive system also comprises a firing pin that is mounted so as to slide in a first shoe.

The firing pin comprises a free end that projects beyond the first shoe and is locked while waiting for a technician to unlock it to strike the explosive cartridge.

When a technician releases the firing pin, the latter strikes the centre of the explosive cartridge, which explodes inside the barrel and, because of the explosion, the shoes separate from each other.

The vertical position of the firing pin is determined with respect to its size and by the fact that its free end must be accessible at the rear of the first shoe. As the cartridge and therefore the barrel are aligned with the firing pin, the thickness of the wall delimiting the bore produced in the second shoe (the upper shoe in the case of the document WO-A-2016/037289) is relatively small and, in some cases, it may happen that the explosion causes a deformation of this wall, which may cause degraded operation of the separating system.

It is therefore necessary to find an arrangement that guarantees, among other things, sufficient thickness of the walls of the bore.

### DISCLOSURE OF THE INVENTION

One object of the present invention is to propose a separating system comprising a hollow body and a movable wedge housed in the hollow body and intended to be used with electrical conductors, wherein each electrical conductor is wedged between the body and the wedge, wherein the separating system also comprises an explosive system with a cartridge and a barrel that are housed in bores with thicker walls than in the case of the prior art.

For this purpose, a separating system for two electrical conductors is proposed, the separating system comprising:
a body in the form of a C-shaped section and having an upper interior face and a lower interior face,
a movable wedge comprising an upper shoe having an upper exterior face facing the upper interior face and a lower shoe having a lower exterior face facing the lower interior face, wherein the upper shoe and the lower shoe are mounted so as to be able to slide with respect to each other along a sliding plane P inside the body, between a close-together position where each exterior face and the facing interior face are separated from each other, and a separated position where each exterior face and the facing interior face are close to each other,
locking means that are arranged to lock the two shoes in the separated position, and
an explosive system that is arranged to ensure passage from the close-together position to the separated position, wherein the explosive system comprises:
a barrel with an open distal end mounted slidably in an upper bore produced in the upper shoe and an open proximal end mounted in a lower bore produced in the lower shoe,
an explosive cartridge housed in the barrel at the proximal end thereof, wherein the explosive cartridge is of the annular percussion type, wherein the rim of the explosive cartridge is arranged outside the barrel,
a firing pin having a percussion zone and mounted so as to be able to slide in a housing of the lower shoe between a waiting position where the percussion zone is at a distance from the bead and a percussed position where the percussion zone strikes the rim,
a spring element that constrains the firing pin in the percussed position, and
a removable holding system that holds the firing pin in the waiting position.

Fitting an explosive cartridge of the annular percussion type makes it possible to offset the barrel upwards and to increase the thickness of the wall delimiting the bore.

Advantageously, the distal end of the barrel has an exterior circular recess coaxial with the axis of the barrel and wherein an O-ring seal is housed, crushed between the bottom of the recess and the wall of the upper bore.

Advantageously, the separating system has a guide mounted fixedly in the housing and having a slot, and the firing pin has an arm mounted slidably inside the slot.

Advantageously, the guide has a curved hollowed-out wall and two slopes arranged on the curved wall, the two slopes separating from the curved wall going from the distal end towards the proximal end of the barrel, and the barrel is in abutment against the slopes.

Advantageously, the barrel extends beyond the slopes going from its distal end towards its proximal end.

Advantageously, the lower shoe has, in line with the lower bore, a complementary bore with a diameter less than the diameter of the lower bore and wherein the rim is housed, and the length of the complementary bore is greater than the thickness of the rim.

### BRIEF DESCRIPTION OF THE DRAWINGS

The features of the invention mentioned above, as well as others, will emerge more clearly from the reading of the following description of an example embodiment, said description being made in relation to the accompanying drawings, among which:

FIG. 1 is a perspective view of a separating system according to the invention in a close-together/loose position,

FIG. 2 is a perspective view of the separating system according to the invention in a separated/clamped position,

FIG. 3 is a view in cross section through a vertical midplane of the separating system according to the invention in the close-together/loose position,

FIG. 4 is a view similar to the one in FIG. 3 in the separated/clamped position,

FIG. 5 is a perspective view of a firing pin used in the separating system according to the invention,

FIG. 6 is a perspective view of a guide used in the separating system according to the invention,

FIG. 7 is a front view of the guide of FIG. 6,

FIG. 8 is a view in cross section along the line VIII-VIII of FIG. 3,

FIG. 9 is a view in cross section along the line IX-IX of FIG. 8, and

FIG. 10 is an enlargement of the detail X in FIG. 3.

### DETAILED DISCLOSURE OF EMBODIMENTS

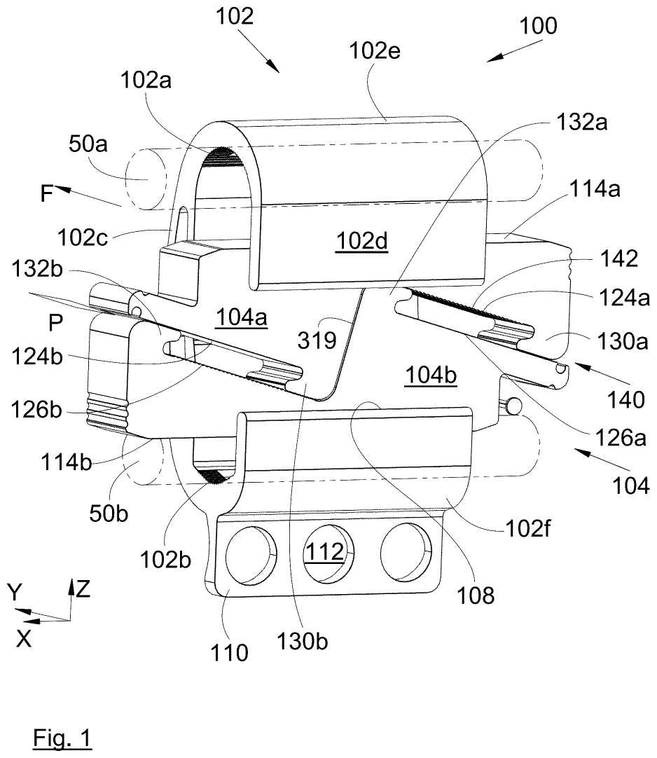

In the following description, the terms relating to a position are taken with reference to a separating system in a position of use, i.e. as shown in FIG. 1.

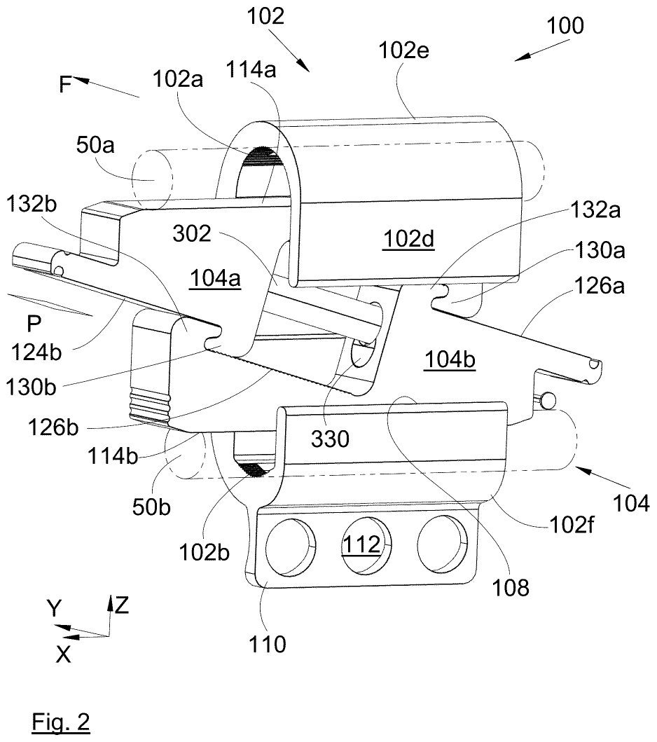

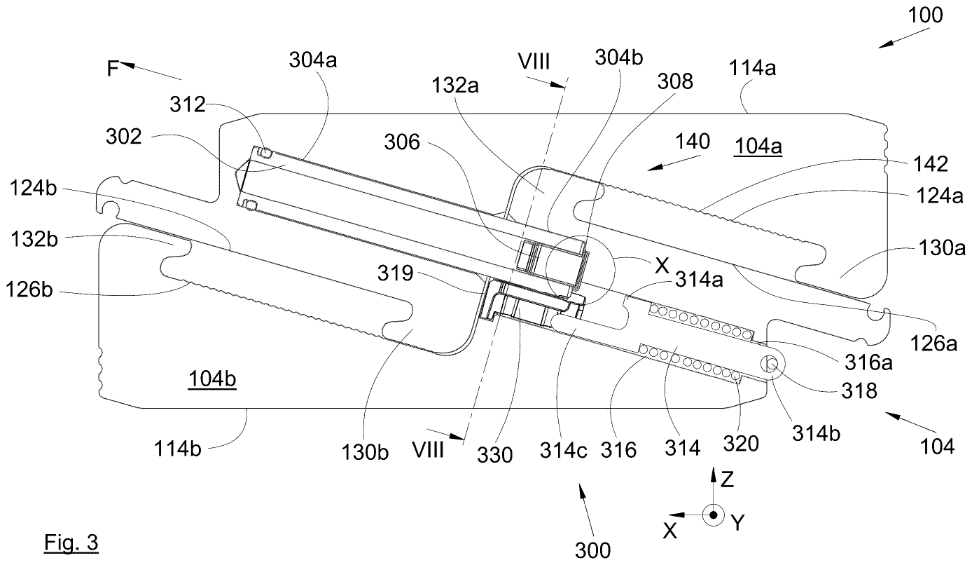

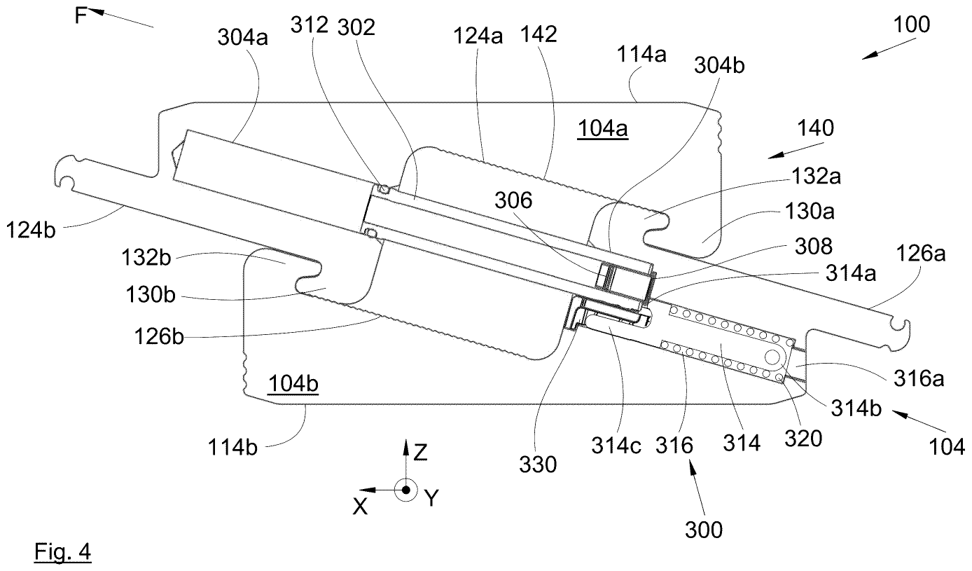

FIGS. 1 to 4 show a separating system 100 according to the invention that comprises a body 102 and a movable wedge 104. The body 102 is in the form of a C-shaped section and the movable wedge 104 comprises two shoes 104a-b that are mounted so as to be able to slide with respect to each other in the body 102 between a close-together position (FIGS. 1 and 3) and a separated position (FIGS. 2 and 4). The two shoes 104a-b are stacked one on the other, with by convention an upper shoe 104a and a lower shoe 104b.

In the close-together position, the two shoes 104a-b are in abutment one against the other along a contact zone 319 and, in the separated position, the two shoes 104a-b are separated at the contact zone 319.

The separating system 100 is used with two electrical conductors 50a-b that are disposed parallel to each other and shown here in phantom lines.

In the following description, and by convention, the longitudinal direction that is parallel to the electrical conductors 50a-b and is here horizontal is called X, the vertical direction that is perpendicular to the two electrical conductors 50a-b and corresponds to the stacking direction of the shoes 104a-b is called Z and the transverse direction, which is also horizontal, is called Y, these three directions X, Y and Z being orthogonal to each other.

The front and rear positions are defined with respect to the direction of movement of the upper shoe 104a with respect to the lower shoe 104b represented by the arrow F.

The C-shaped section constituting the body 102 has two parallel lateral walls 102c-d, one of which is separated in two by a lateral slot 108 that enables electrical conductors 50a-b to be inserted. In the top part, the two lateral walls 102c-d are connected by an upper curved wall 102e and, at the bottom part, the two lateral walls 102c-d are connected by a lower curved wall 102f.

The lower curved wall 102f is here secured to a leg 110 that is pierced with holes 112 (here three in number) that make it possible for example to hold the body 102 or to secure it to a support.

The body 102 has, for each electrical conductor 50a-b, an interior face 102a-b produced at each curved wall 102e-f and which is therefore here curved in shape and against which the electrical conductor 50a-b comes into abutment in the separated position of the shoes 104a-b.

The two shoes 104a-b are disposed between the interior faces 102a-b and between the lateral walls 102c-d. The two shoes 104a-b and the interior faces 102a-b are aligned parallel to the vertical direction Z.

The upper shoe 104a has an upper exterior face 114a perpendicular to the vertical direction Z and which is facing the upper interior face 102a of the upper curved wall 102e, and the lower shoe 104b has a lower exterior face 114b perpendicular to the vertical direction Z and which is facing the lower interior face 102b of the lower curved wall 102f.

The upper shoe 104a has an upper exterior face 114a facing the upper interior face 102a, and the lower shoe 104b has a lower exterior face 114b facing the lower interior face 102b. Each exterior face 114a-b is here perpendicular to the vertical direction Z.

Each electrical conductor 50a-b is disposed between an exterior face 114a-b and the facing interior face 102a-b.

The two shoes 104a-b are able to move with respect to each other inside the body 102 between the close-together position that corresponds to a loose position of the conductors 50a-b where the latter are not clamped against an exterior face 114a-b and an interior face 102a-b, i.e. where each exterior face 114a-b and the facing interior face 102a-b are distant from each other, and the separated distance, which corresponds to a clamped position of the conductors 50a-b where the latter are clamped between an exterior face 114a-b and an interior face 102a-b, i.e. where each exterior face 114a-b and the facing interior face 102a-b are close to each other.

The two shoes 104a-b are able to move along an oblique sliding plane P that is parallel to the transverse direction Y and is inclined between a horizontal plane XY and a vertical plane YZ and which, in the embodiment presented in FIGS. 1 to 4, makes an angle of the order of 15° with the horizontal plane XY.

As the two shoes 104a-b are constrained by the side walls 102c-d of the body 102, the direction of movement of the upper shoe 104a with respect to the lower shoe 104b represented by the arrow F is parallel to the sliding plane P and parallel to the side walls 102c-d of the body 102.

Each shoe 104a-b has two sliding faces 124a-b, 126a-b that are parallel to the sliding plane P and distant from each other perpendicularly to the sliding plane P. The upper shoe 104a has a first upper sliding face 124a and a second upper sliding face 124b, and the lower shoe 104b has a first lower sliding face 126a and a second lower sliding face 126b.

The first upper sliding face 124a is facing and at a distance from the first lower sliding face 126a and the second upper sliding face 124b is facing and at a distance from the second lower sliding face 126b.

For each shoe 104a-b, the first sliding face 124a, 126a is offset vertically upwards with respect to the second sliding face 124b, 126b.

For each sliding face 124a-b, 126a-b of a shoe 104a-b, the other shoe 104b-a comprises a foot 130a-b, 132a-b that is in flat abutment against said sliding face 124a-b, 126a-b in order to provide the sliding.

To ensure the locking of the two shoes 104a-b in the separated position, the separating system 100 comprises locking means 140 that are here produced in the form of notches 142 produced on at least one sliding face 124a-b, 126a-b and on the foot 130a-b, 132a-b in abutment on said at least one sliding face 124a-b, 126a-b. The notches 142 of the sliding face 124a-b, 126a-b and of the associated foot 130a-b, 132a-b interact to block the translation in the separated position. The notches 142 here form serrations perpendicular to the direction of movement of the upper shoe 104a (arrow F).

To prevent the shoes 104a-b moving beyond the separated position and separating entirely from each other, the feet 130a-b and 132a-b are shaped in the form of hooks, and the hooks formed by the feet of the lower shoe 104b are inserted in the hooks formed by the feet of the upper shoe 104a and vice versa to block the translation. According to the diameter of the electrical conductors 50a-b, the separated position corresponds to a position where the shoes 104a-b are more or less distant from each other at the contact zone 319. FIG. 2 corresponds to a maximum separation position, but an intermediate separated position is possible if the electrical conductors 50a-b are larger, and the feet 130a-b and 132a-b do not then come into contact.

The passage from the close-together position to the separated position is implemented by means of an explosive system of the separating system 100.

FIG. 3 shows the non-percussed explosive system 300 and FIG. 4 shows the percussed explosive system 300.

The explosive system 300 comprises a barrel 302 that has an open distal end that is mounted slidably in an upper bore 304a produced in the upper shoe 104a and an open proximal end that is mounted in a lower bore 304b produced in the lower shoe 104b.

The axis of the barrel 302, and the axes of the upper 304a and lower 304b bores are broadly coaxial and parallel to the direction of movement of the upper shoe 104a (arrow F).

An explosive cartridge 306 is housed in the barrel 302 at the proximal end thereof, wherein the explosive cartridge 306 is of the annular percussion type, and wherein the rim 308 of the explosive cartridge 306 is arranged outside the barrel 302 and contains the priming composition.

The explosive system 300 comprises a firing pin 314 that is mounted so as to be able to slide, here parallel to the direction of movement of the upper shoe 104a (arrow F), in a housing 316 of the lower shoe 104b between a waiting position (FIG. 3) and a percussed position (FIG. 4).

The firing pin 314 has a percussion zone 314a.

In the waiting position, the percussion zone 314a is at a distance from the rim 308 parallel to the direction of movement of the upper shoe 104a (arrow F), and, in the percussed position, the percussion zone 314a strikes the rim 308 containing the priming composition necessary for the explosion of the explosive cartridge 306.

The explosive system 300 comprises a spring element 320, here a compression spring, that constrains the firing pin 314 in the percussed position. The passage from the waiting position to the percussed position is provided by the spring element 320, which is compressed and in which the kinetic energy necessary for the percussion of the explosive cartridge 306 is stored.

As with the prior art, the firing pin 314 has a free end 314b that is opposite to the percussion zone 314a and which, in the waiting position, projects beyond the lower shoe 104b through an extension 316a of the housing 316 that passes through a rear wall of the lower shoe 104b. The firing pin 314 is held in the waiting position by a removable holding system 318 of the explosive system 300, which is here in the form of a rod passing through a piercing of the free end 314b. The holding system 318 also keeps the spring element 320 under tension, i.e. here keeps the compression spring compressed.

When the holding system 318 is withdrawn, the firing pin 314 moves towards the percussed position under the effect of the spring element 320, where the percussion zone 314a strikes the rim 308, which causes the explosive cartridge 306 to explode. When the holding system 318 is withdrawn, the spring element 320 is released and the stored kinetic energy thereof pushes the firing pin 314.

This explosion causes the generation of pressurised gas and causes, at the open distal end, a propulsion of the upper shoe 104a and of the lower shoe 104b towards the separated position.

In the embodiment of the invention presented here, the housing 316 is in the form of a hollow cylinder that passes right through the lower shoe 104b and has a first end that emerges outside rearwards at the extension 316a and a second end that emerges forwards at the top part at the lower bore 304b and at the bottom part at the contact zone 319.

As with the prior art, the vertical position of the firing pin 314 is determined with respect to its size and by the fact that its free end 314b must be accessible at the rear of the lower shoe 104b. Because of the annular percussion of the explosive cartridge 306, said explosive cartridge 306 and therefore the barrel 302 must be offset with respect to the position of the prior art. The offset takes place upwards, i.e. the upper bore 304a is produced higher inside the upper shoe 104a and the thickness of the wall between the interior of the upper bore 304a and the second sliding face 124b is greater than in the case of the prior art.

To obtain a better blast effect when the explosive cartridge 306 explodes, the distal end of the barrel 302 has an exterior circular recess coaxial with the axis of the barrel 302 and wherein an O-ring seal 312 is housed, which is crushed between the bottom of the recess and the wall of the upper bore 304a.

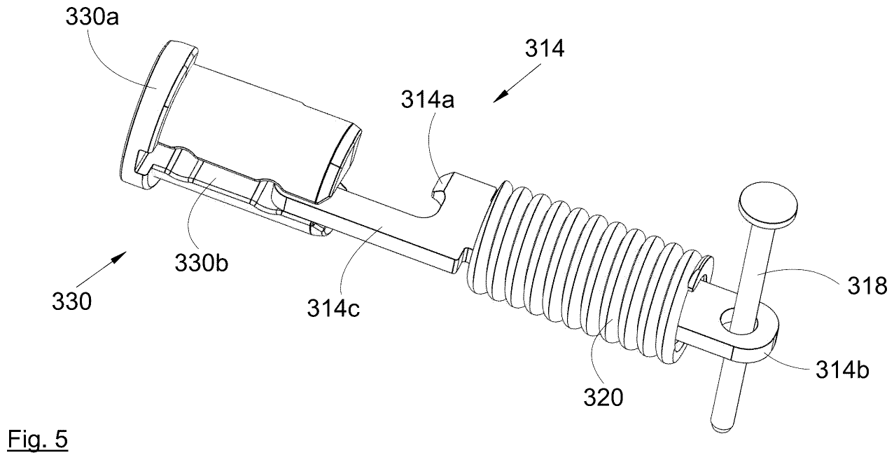

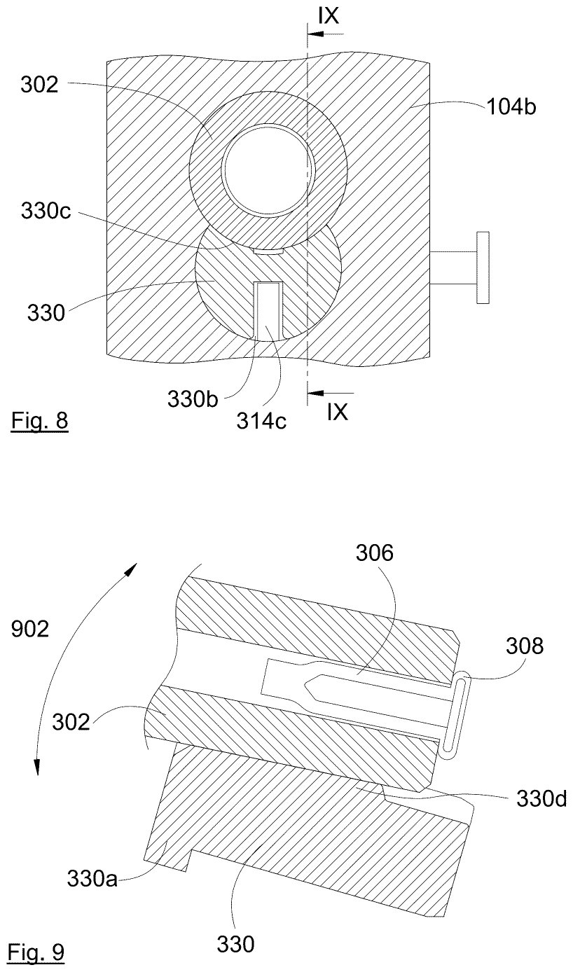

The firing pin 314 is guided during the movement thereof between the waiting position and the percussed position by a guide 330 that is seen more precisely in FIGS. 5 to 9.

The guide 330 has here a roughly cylindrical shape and is inserted in the housing 316 at the second end.

The guide 330 has a collar 330a that limits its driving towards the first end in the housing 316. The guide 330 is driven with a tight fit in the housing 316.

The guide 330 has a slot 330b that extends parallel to the direction of movement of the upper shoe 104a (arrow F), and the firing pin 314 has an arm 314c that is also parallel to the direction of movement of the upper shoe 104a (arrow F) and which is mounted so as to slide inside the slot 330b to provide the guidance of the firing pin 314 during movement thereof.

The width of the slot 330b and the thickness of the arm 314c are such that the arm 314c moves in translation inside the slot 330b but the angular movement thereof is limited to ensure that the percussion zone 314a does indeed strike the rim 308.

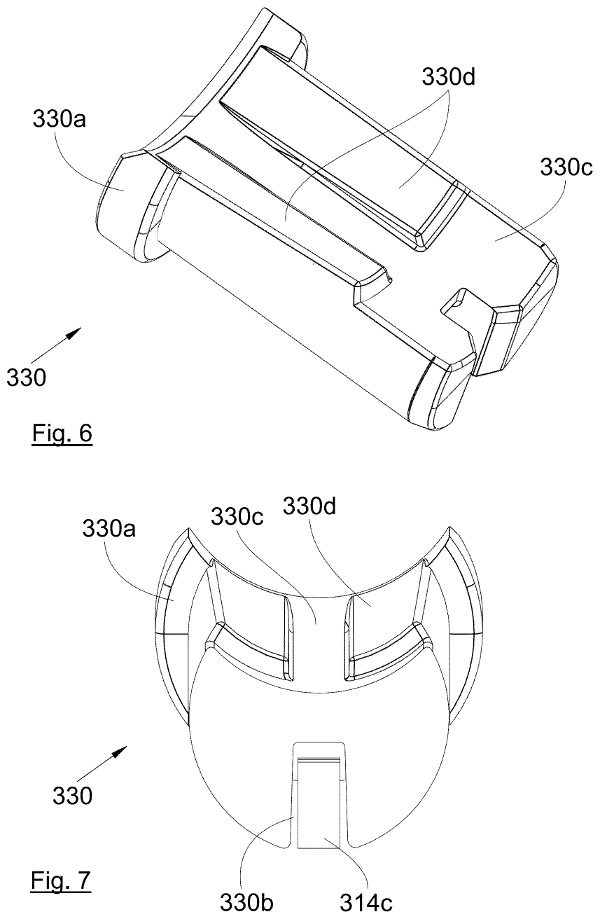

The guide 330 has at the top part a curved wall 330c that is hollowed out and facing which the barrel 302 is positioned. As shown by FIGS. 6 and 7, the guide 330 has, on the curved wall 330c, two slopes 330d that are secured to the curved wall 330c and move away from the curved wall 330c while progressing from front to rear, i.e. from the distal end towards the proximal end of the barrel 302. The slopes 330d are disposed on either side of a vertical midplane passing through the axis of the guide 300 and of the barrel 302.

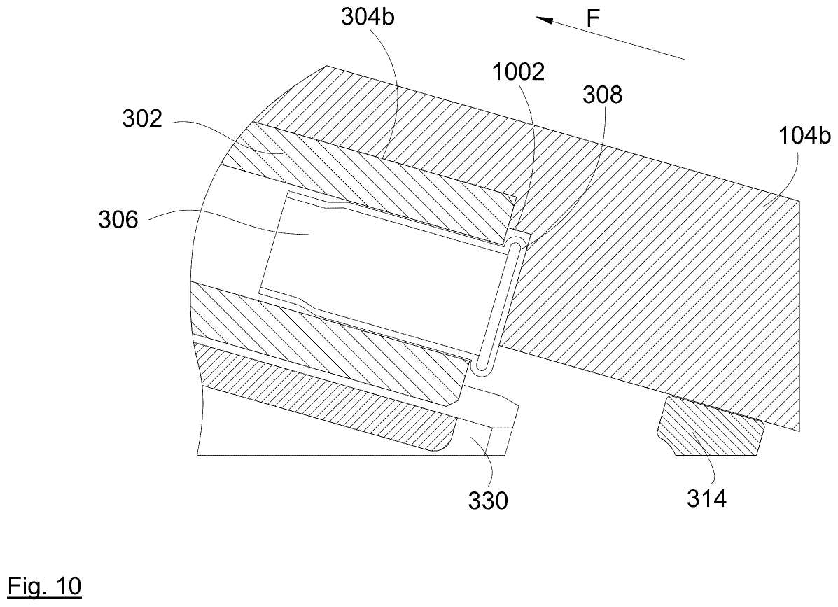

As shown in FIG. 9, the barrel 302 is in abutment against the slopes 330d and the form of the slopes 330d provides clamping of the barrel 302 at the proximal end thereof in the lower bore 304b.

The clamping of the proximal end of the barrel 302 ensures that the barrel 302 remains secured to the lower shoe 104b even during the explosion.

The barrel 302 extends beyond the slopes 330d while moving from its distal end towards its proximal end and therefore projects at the rear of the slopes 330d.

Because of the presence of the notches 142, the movements of the shoes 104a-b take place in the form of a succession of steps that force the barrel 302 to oscillate about its axis in a vertical plane.

The presence of the slopes 330d and the projection of the barrel 302 beyond the slopes 330d facilitate the oscillations of the barrel 302 as represented by the double arrow 902 in FIG. 9 and prevent damage to the barrel 302.

To increase the percussion force of the percussion zone 314a on the rim 308, said percussion zone 314a is cut to a point and is here bevelled to reduce its surface of contact with the rim 308.

FIG. 10 shows a particular embodiment of the invention at the explosive cartridge 306. The proximal end of the barrel 302 is in abutment against the bottom of the lower bore 304b.

The lower shoe 104b has, towards the rear, in line with the lower bore 104b, a complementary bore 1002 with a diameter less than the diameter of the lower bore 304b and wherein the rim 308 is housed. The length of the complementary bore 1002 parallel to the direction of movement of the upper shoe 104a (arrow F) is greater than the thickness of the rim 308 so that the latter can be housed therein without being crushed between the bottom of the complementary bore 1002 and the proximal end of the barrel 302, which could accidentally trigger the explosion.

1. A separating system for two electrical conductors, the separating system comprising:
a body in the form of a C-shaped section and having an upper interior face and a lower interior face,
a movable wedge comprising an upper shoe having an upper exterior face facing the upper interior face and a lower shoe having a lower exterior face facing the lower interior face, wherein the upper shoe and the lower shoe are mounted so as to be able to slide with respect to each other along a sliding plane P inside the body, between a close-together position where each exterior face and the facing interior face are separated from each other, and a separated position where each exterior face and the facing interior face are close to each other,
locking means that are arranged to lock the two shoes in the separated position, and
an explosive system that is arranged to ensure passage from the close-together position to the separated position, wherein the explosive system comprises:
a barrel with an open distal end mounted slidably in an upper bore produced in the upper shoe and an open proximal end mounted in a lower bore produced in the lower shoe,
an explosive cartridge is housed in the barrel at the proximal end thereof, wherein the explosive cartridge is of the annular percussion type, and wherein the rim of the explosive cartridge is arranged outside the barrel,
a firing pin having a percussion zone and mounted so as to be able to slide in a housing of the lower shoe between a waiting position where the percussion zone is at a distance from the bead and a percussed position where the percussion zone strikes the rim,
a spring element that constrains the firing pin in the percussed position, and
a removable holding system that holds the firing pin in the waiting position.

2. The separating system according to claim 1, wherein the distal end of the barrel has an exterior circular recess coaxial with the axis of the barrel and wherein an O-ring seal is housed, crushed between the bottom of the recess and the wall of the upper bore.

3. The separating system according to claim 1, further comprising a guide mounted fixedly in the housing and having a slot, and in that the firing pin has an arm mounted slidably inside the slot.

4. The separating system according to claim 3, wherein the guide has a curved hollowed-out wall and two slope arranged on the curved wall, in that the two slopes separate from the curved wall going from the distal end towards the proximal end of the barrel, and in that the barrel is in abutment against the slopes.

5. The separating system according to claim 4, thatwherein the barrel extends beyond the slopes going from its distal end towards its proximal end.

6. The separating system according to claim 1, wherein the lower shoe has, in line with the lower bore, a complementary bore with a diameter less than the diameter of the lower bore and wherein the rim is housed, and in that the length of the complementary bore is greater than the thickness of the rim.
